(19) United States
(12) Patent Application Publication
(10) Pub. No.: US 2024/0157638 A1
(43) Pub. Date: May 16, 2024

(54) ADDITIVE CHEMISTRIES, METHODS, AND SYSTEMS FOR ADDITIVE MANUFACTURING

(71) Applicant: Nexa3D Inc., Ventura, CA (US)

(72) Inventors: Nirup Nagabandi, Pflugerville, TX (US); Jason Masao Summers, Cedar Park, TX (US); Natalie Pardivala Herrin, Austin, TX (US); Alex LaVelle, Austin, TX (US)

(21) Appl. No.: 18/419,357

(22) Filed: Jan. 22, 2024

Related U.S. Application Data
(63) Continuation-in-part of application No. PCT/US22/38060, filed on Jul. 22, 2022.
(60) Provisional application No. 63/224,844, filed on Jul. 22, 2021.
(60) Provisional application No. 63/224,842, filed on Jul. 22, 2021.

(51) Int. Cl. B29C 64/209; B29C 64/295; B29C 64/321; B29C 64/393; B33Y 30/00; B33Y 40/00; B33Y 50/02

(52) U.S. Cl. CPC B29C 64/209; B29C 64/295; B29C 64/321; B29C 64/393; B33Y 30/00; B33Y 40/00; B33Y 50/02

(57) ABSTRACT

A three-dimensional printer for generating a printed component is provided. The three-dimensional printer includes a build substrate defining a surface that supports the printed component and a print head moveable relative to the build substrate. The three-dimensional printer also includes a nozzle mounted to the print head including a nozzle tip, and a heater mounted to the print head adjacent to the nozzle including one or more heating elements.

### RELATED APPLICATIONS

This is a CONTINUATION-IN-PART of International Application No. PCT/US2022/038060, filed 22 Jul. 2022, which claims priority from U.S. patent application Ser. No. 17/478,048, filed 17 Sep. 2021, and U.S. Provisional Application Nos. 63/224,844, filed 22 Jul. 2021, and 63/224,842, filed 22 Jul. 2021, each of which is incorporated herein by reference in its respective entirety.

### FIELD OF THE INVENTION

The present invention is directed to additive chemistries, methods, and systems for additive manufacturing, and more specifically to the use of a heater that enables the use of additive chemistries for in-situ curing of thermoset resins as well as providing improvements for build, or z-direction, properties for both thermoplastic and thermoset materials.

### BACKGROUND

The statements in this section merely provide background information related to the present disclosure and may or may not constitute prior art.

Three-dimensional printing, which may also be referred to as additive manufacturing, generates printed components based on computer models. Additive manufacturing techniques may be used to generate large, relatively complex components. In one approach, a three-dimensionally printed component may be created by depositing a feedstock, such as a thermoplastic filament, through a nozzle in successive layers upon a base plate. However, since additive manufacturing techniques involve building parts layer by layer, the resulting printed components exhibit anisotropic mechanical properties. For example, three-dimensionally printed components tend to exhibit relatively lower tensile strength in the build, or z-, direction than in the in the x-, y-direction.

Thus, while current thermoplastic systems and three-dimensional printing techniques achieve their intended purpose, there is room for the development of new and improved material systems and 3D printing methods for forming three-dimensionally printed objects.

### SUMMARY

According to various aspects, the present disclosure relates to a three-dimensional printer for generating a printed component. The three-dimensional printer includes a build substrate defining a surface that supports the printed component and a print head moveable relative to the build substrate. The three-dimensional printer further includes a nozzle mounted to the print head including a nozzle tip and a heater mounted to the print head adjacent to the nozzle including one or more heating elements.

In aspects of the above, the three-dimensional printer includes at least two heaters, and the heating elements include infrared lamps.

In any of the above aspects, the at least two heaters are connected to the print head by clamps or mounting brackets.

In any of the above aspects, the print head includes a nozzle and the nozzle includes channel defined therein. In addition, the channel includes a plurality of legs and a plurality of mixing elements retained within the legs.

In any of the above aspects, a buffer is attached to the nozzle, wherein the buffer includes a manifold and at least two channels defined in the manifold.

In any of the above aspects, the manifold is connected to an adapter and the channels extend through the adapter and merge at a base of the adapter.

In any of the above aspects, the nozzle includes a first flange and the adapter includes a second flange and the flanges are connected together to retain the adapter against the nozzle.

In any of the above aspects, the three-dimensional printer further includes at least two pumps, wherein each pump is connected to one of the at least two channels defined in the manifold.

In aspects of the above, each pump includes a peristaltic pump.

In aspects, the heater includes a main body that defines an opening for receiving the nozzle and the one or more heating elements are configured to heat at least a portion of the heater to a predefined temperature.

In aspects of the above, the nozzle is heated.

In any of the above aspects, the three-dimensional printer further includes a temperature sensor operatively coupled to the heater and control module connected to the heating elements. The control module is configured to execute instructions to: monitor the one or more temperature sensors for electronic signals indicating the temperature of the heater, determine a current temperature of the heater based on the electronic signals from the one or more temperature sensors, and instruct the one or more heating elements to increase, decrease, or maintain the temperature of the heater based on the current temperature of the heater.

According to several aspects, the present disclosure also relates to a three-dimensional printer for printing a thermoset. The three-dimensional printer includes a nozzle mounted in a print head, wherein the print head moveable in a first plane. In addition, the nozzle includes a plurality of mixing elements. The three-dimensional printer also includes a buffer coupled to the nozzle. The three-dimensional printer further includes a first flow path including a first end and a second end, the first end connected to a first supply container and the second end connected to the buffer, and a second flow path including a first end and a second end, the first end connected to a second supply container and the second end connected to the buffer. The three-dimensional printer further includes a pump connected to the supply container and the second end of the flow path. The three-dimensional printer yet further includes a heater connected to the print head, wherein the heater includes an infrared lamp heating element.

According to several aspects, the present disclosure further relates to a system for forming three-dimensional components. The system includes a nozzle mounted in a print head, wherein the nozzle includes a plurality of mixing elements. The system further includes a buffer coupled to the nozzle. The system yet further includes a first flow path including a first end and a second end, the first end connected to a first supply container and the second end connected to the buffer, and a second flow path including a first end and a second end, the first end connected to a second supply container and the second end connected to the buffer. The system also includes a pump operatively connected to the supply container and the second end of the flow path. In addition, the system includes a first thermoset resin component present in the first supply container and a second thermoset resin component present in the second supply container. Further, the system includes a heater connected to the print head, wherein the heater includes an infrared lamp.

In aspects of the above, at least one of the first thermoset resin component and the second thermoset resin component includes particles. The particles heat the first and second thermoset resin components upon exposure to the heater.

According to several aspects, the present disclosure further relates to a method of printing a three-dimensional component. The method includes delivering at least two components of a thermoset resin system from a supply container to a buffer, wherein the buffer is connected to a nozzle, and merging the at least two components of the thermoset resin system in the buffer. The method also includes mixing the at least two components of the thermoset resin system with a plurality of mixing elements provided in the nozzle and depositing the thermoset resin system onto a build substrate in a plurality of layers. The method further includes heating the thermoset resin system with a heater as it is being deposited and at least partially crosslinking a layer currently being deposited and crosslinking a previously deposited layer with the layer currently being deposited.

In aspects of the above, at least one of the thermoset resin components includes particles, and the method further comprises heating the particles in the thermoset resin.

In further aspects, the method includes heating the thermoset resin system with the particles.

According to several aspects, the present disclosure is directed to a method of printing a three-dimensional component. The method includes delivering at least two components of a thermoset resin system from a supply container to a buffer, wherein the buffer is connected to a nozzle. Further, at least one of the components includes electrically active particles. The method also includes merging the at least two components of the thermoset resin system in the buffer and mixing the at least two components of the thermoset resin system with a plurality of mixing elements provided in the nozzle. The method further includes depositing the thermoset resin system onto a build substrate in a plurality of layers. The method yet also includes heating the electrically active particles in the thermoset resin system with an electrical field applicator as the thermoset resin system is being deposited and at least partially crosslinking a layer currently being deposited and crosslinking a previously printed layer with the layer currently being deposited.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 illustrates a perspective view of a three-dimensional printer, according to an embodiment of the present disclosure.

FIG. 2 is a perspective view illustrating a bottom portion of a print head, a tool head, a heater, and a mounting fixture for the heater of a three-dimensional printer, according to an embodiment of the present disclosure.

FIG. 3 is a side view of the tool head, the heater, and the mounting fixture for the heater seen in FIG. 2, as well as a nozzle and a printed component, according to an embodiment of the present disclosure.

FIG. 4 is a schematic diagram of the heater including one or more heating elements and one or more temperature sensors in electronic communication with a control module, according to an embodiment of the present disclosure.

FIG. 5A is a front view of a tool head, heater including IR elements, and a mounting fixture, according to an embodiment of the present disclosure.

FIG. 5B is a front view of a tool head, heater including IR elements, and a mounting fixture, according to an embodiment of the present disclosure.

FIG. 5C is a perspective bottom view of a tool head including a heater with IR elements and a mounting fixture, according to an embodiment of the present disclosure.

FIG. 5D is a perspective bottom view of the heater with IR elements, a mounting fixture, and a blower, according to an embodiment of the present disclosure.

FIG. 5E is a heater including IR elements, according to an embodiment of the present disclosure.

FIG. 5F is a perspective bottom view of the heater with IR elements, a mounting fixture, and a blower, according to an embodiment of the present disclosure.

FIG. 6 illustrates a bottom view of a heat plate, such as the heat plate of FIGS. 2 and 3, according to an embodiment of the present disclosure.

FIG. 7A illustrates a bottom view of a heater according to an embodiment of the present disclosure.

FIG. 7B illustrates a bottom view of a heater according to an embodiment of the present disclosure.

FIG. 7C illustrates a bottom view of a heater according to an embodiment of the present disclosure.

FIG. 7D illustrates a bottom view of a heater according to an embodiment of the present disclosure.

FIG. 8A illustrates a thermoset resin supply system according to an embodiment of the present disclosure.

FIG. 8B illustrates a thermoset resin buffer and nozzle according to an embodiment of the present disclosure.

FIG. 9A illustrates a thermoset mixing nozzle according to an embodiment of the present disclosure. The thermoset nozzle optionally includes an insulation jacket, illustrated so that the configuration of the nozzle underneath the jacket is visible.

FIG. 9B illustrates a view of the mixing nozzle of FIG. 9A including some portions illustrated in transparent so internal features of the nozzle are visible, according to an embodiment of the present disclosure.

FIG. 10A illustrates a thermoset mixing nozzle according to an embodiment of the present disclosure.

FIG. 10B illustrates a view of the mixing nozzle of FIG. 10A including some portions illustrated in transparent, according to an embodiment of the present disclosure.

FIG. 11A illustrates a feed system for dispensing thermoset resin system components from a pump, according to an embodiment of the present disclosure.

FIG. 11B illustrates a peristaltic pump, according to an embodiment of the present disclosure.

FIG. 12 illustrates an electrical field applicator according to an aspect of the present disclosure.

FIG. 13 is a graph that illustrates the effect of temperature on the average ultimate tensile strength of a printed component printed on a three-dimensional printer including a print head.

FIG. 14 is a graph that illustrates the effect of average temperature of the heat plate on the depth the component is at 60° C.

FIG. 15 is a graph that illustrates the effect of the heater on the ultimate tensile strength of a printed part.

FIG. 16 illustrates an two needles including reference marks created at an equal distance from the bottom of each needle, the left needle being positioned over an area exposed to an electric field and the right need being positioned over an area unexposed to the electric field, wherein the needle on the left did not sink into the thermoset resin system where the resin system was exposed to the electric field, whereas the needle on the right sank into the resin system in the area that was not exposed to the electric field.

FIG. 17 is a representation of the texture of the cured samples.

FIG. 18 is a graph illustrating the effect of filler loading percentage on gel times of various formulations with and without the application of an electric field.

### DETAILED DESCRIPTION

The following description is merely exemplary in nature and is not intended to limit the present disclosure, application, or uses.

The present disclosure is directed, in part, to a heater for a three-dimensional printer that creates a volume of hot air or directed energy in the form of radiation or joule heating for locally heating or reheating a portion of a printed component, thereby improving the interlayer bonding between successive layers of the printed component. In aspects, the heater is used in combination with a thermoset resin system and a thermoset resin delivery system. In further aspects, the heater is replaced by an electric field applicator.

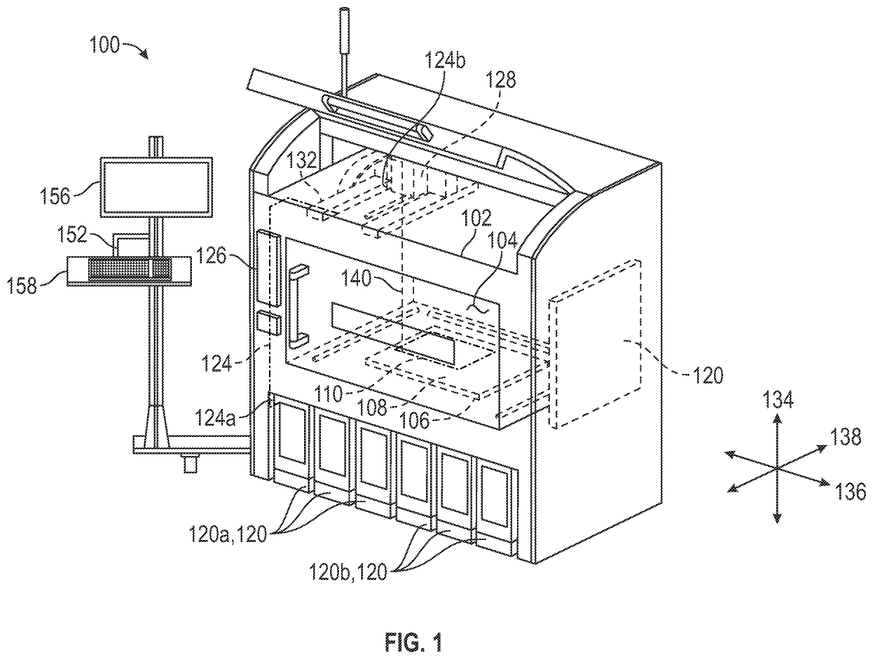

Referring now to FIG. 1, FIG. 1 illustrates an aspect of a three-dimensional printer 100. The three-dimensional printer 100 generally includes a housing 102, a process chamber 104 defined by the housing 102, and a build substrate 106 defining a print surface 108, for supporting a printed component 110. The three-dimensional printer 100 also includes a series of supply containers 120 containing the feedstock 140 for printing, including either thermoplastic filament or thermoset resin system components. In aspects of thermoset printing, the supply containers 120a, 120b (collectively referred to herein as supply containers 120) contain the different reactive components for a thermoset resin system. While the supply containers 120 are illustrated as being positioned at the base of the three-dimensional printer 100, they may be located in other areas, such as at the top of the three-dimensional printer 100, behind the three-dimensional printer, etc. In aspects where thermoset printing is desired, the supply containers 120 may be provided at the top of the three-dimensional printer 100, in the base of the three-dimensional printer 100, or otherwise located outside of the three-dimensional printer housing 102.

The three-dimensional printer 100 further includes a flow path 124 connected at a first end 124a to the supply containers 120 and at a second end 124b to the print head 128. It should be appreciated that where multiple reactive components are provided, a flow path 124 is provided for each of the different reactive components. In aspects, the flow path 124 is formed from tubing. The print head 128 is suspended from a gantry 132 that moves the print head 128 throughout a first plane defined by a first axis 136 and second axis 138. The print head 128 deposits the feedstock 140 onto the print surface 108 of the build substrate 106 to form the printed component 110. The build substrate 106 is mounted in the housing 102 on a drive system that provides movement in a third axis 134 orthogonal to the plane defined by the first axis 136 and the second axis 138. The build substrate 106 may be formed from a variety of materials such as borosilicate glass, stainless steel, polyetherimide, G10 or Garolite, BUILDTAK (available from BuildTak), etc. The various functions in the three-dimensional printer 100, including the rate of feedstock 140 deposition, the motion of the print head 128, the motion of the build substrate 106, etc., are controlled by a control module 152. The control module 152 includes input/output devices, such as a touch screen display monitor 156, as well as one or more processors 158 for executing instructions for operating the various components of the three-dimensional printer 100 and collecting sensor data for sensor located throughout the three-dimensional printer 100.

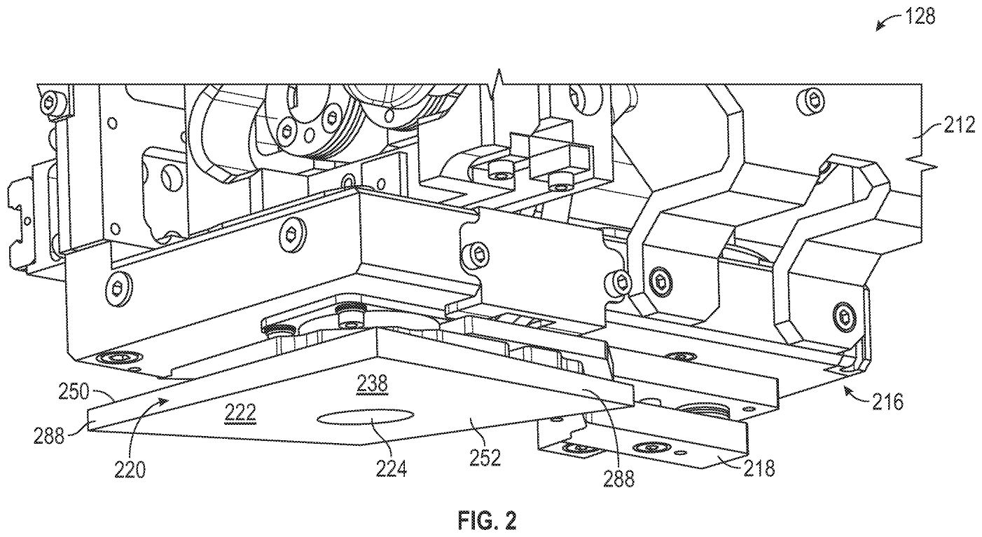

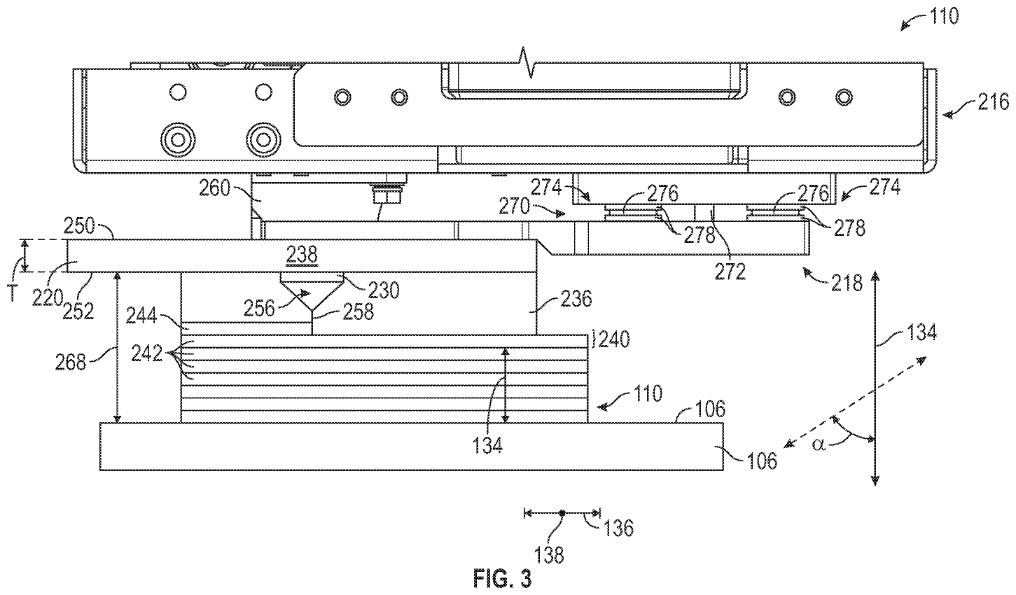

FIG. 2 illustrates a perspective view of an aspect of a print head 128 including a heater 220. The bottom portion 212 of a print head 128 is illustrated. The three-dimensional printer 100 includes a tool head 216 located at the bottom portion 212 of the print head 128, a mounting fixture 218, and a heater 220. The mounting fixture 218 is located beneath the tool head 216 and attaches the heater 220 to the tool head 216 of the three-dimensional printer 100. The heater 220 includes a heat plate 222 defining an opening 224. FIG. 3 illustrates a side view of the tool head 216, the mounting fixture 218, and the heater 220 shown in FIG. 2 in addition to a nozzle 230, a build substrate 106, and a printed component 110 that is presently being generated by the three-dimensional printer 10. Referring to FIG. 3, a volume of hot air 236 is created between the heater 220 and the printed component 110 when at least a portion of the heater 220 is heated to a predefined temperature. Further, in aspects, the heat plate 222 may directly transfer energy to the one or more successive layers 242 deposited on the build substrate 106 as well as to the layer 244 currently being deposited on the build substrate 106 and previously deposited successive layers 242 via radiation or joule heating.

As explained below, the volume of hot air 236 is located between a lower surface 252 of the heater 220 and a portion 240 of the printed component 110. Specifically, the portion 240 of the printed component 110 includes one or more successive layers 242 of the printed component 110 most recently deposited by the nozzle 230. The volume of hot air 236 is at an air temperature that locally heats the portion 240 of the printed component 110 to a fusing temperature when printing with thermoplastic filament as the feedstock 140 or crosslinking temperature when printing with thermoset resin as the feedstock 140. When reheated to the fusing temperature, the one or more successive layers 242 of the printed component 110 bond to a current layer 244 presently being extruded by a heated nozzle 230, which in turn improves the interlayer bonding between the successive layers 242 of the printed component 110. When heated to the crosslinking temperature, the one or more successive layers 242 of the printed component 110 crosslinks to a current layer 244 presently being extruded by the nozzle 230, which in turn improves the interlayer bonding between the successive layers 242 of the printed component 110. Improving the interlayer bonding between the successive layers 242 improve the tensile strength of the printed component 110 in a Z axis 134 direction. As seen in FIG. 3, the Z axis 134 direction is perpendicular to a build direction X,Y 136, 138 of the printed component 110. In some embodiments, the printed component 110 includes near-isotropic tensile strength because of the improved interlayer bonding.

Referring specifically to FIG. 3, the build substrate 106 defines a print surface 108 that supports the printed component 110. The nozzle 230 includes a nozzle tip 256. The nozzle 230 is configured to deposit an extruded build material 258 upon either the build substrate 106 or the printed component 110. Specifically, the build material 258 may be in the form of a thermoplastic filament that is fed as a feedstock 140 into the print head 128 through a receiver (not shown in the figures) that is part of the print head 128 (FIG. 2) or in the form of a thermoset resin that is fed as a feedstock 140 into the print head 128 through a mixer, which may be integrated into the nozzle 130 (described further below). In aspects of depositing a thermoplastic filament feedstock 140, the nozzle 230 is heated; whereas, in aspects of depositing a thermoset feedstock 140, the nozzle 230 may or may not be heated, and in some instances may be air or water cooled to prevent premature crosslinking during delivery.

Referring to both FIGS. 2 and 3, the opening 224 defined by the heat plate 222 of the heater 220 is shaped to receive the nozzle 230 and nozzle tip 256. The heater 220 is constructed of a thermally conductive material such as, for example, aluminum or steel, and is in the shape of a plate. In aspects, an outermost surface 238 of the heater 220 is covered with black thermal paint so the heater 220 functions as a black body. In an embodiment, the heater 220 includes a thickness T (seen in FIG. 2) that ranges from about 1 to about 100 millimeters, including all values and ranges therein. In some embodiments, the three-dimensional printer 100 may include a part blower duct 260 (FIG. 3) that surrounds the nozzle 230 (FIG. 3), where the part blower duct 260 generates air that is directed towards the printed component 110 (FIG. 3). In particular, the part blower duct 260 may be used to provide air that cools relatively smaller features of the printed component 110.

Continuing to refer to both FIGS. 2 and 3, the heater 220 includes an upper surface 250 and the lower surface 252. The upper surface 250 of the heater 220 faces the tool head 216 of the three-dimensional printer 100, and the lower surface 252 of the heater 220 faces the print surface 108 of the build substrate 106 supporting the printed component 110. As seen in FIG. 3, the lower surface 252 of the heater 220 is oriented parallel with respect to the print surface 108 of the build substrate 106. In the example as shown in FIG. 3, the lower surface 252 of the heater 220 and the print surface 108 of the build substrate 106 are both oriented perpendicular with respect to axis 134 that is oriented straight up and down. That is, the lower surface 252 of the heater 220 and the print surface 108 of the build substrate 106 are both oriented flat. However, it is to be appreciated that the print surface 108 of the build substrate 106 may be oriented at an angle depending upon the specific requirements and geometry of the printed component 110. For example, the print surface 108 of the build substrate 106 may be tilted at an angle α relative to the axis 134. In this example, since the lower surface 252 of the heater 220 is parallel with the print surface 108 of the build substrate 106, the heater 220 is also tilted at the angle α.

The mounting fixture 218 not only attaches the heater 220 to the tool head 216, but also orients the heater 220 parallel with respect to the print surface 108 of the build substrate 106. Referring specifically to FIG. 3, the mounting fixture 218 includes one or more adjustment assemblies 270 for adjusting a vertical distance 268 measured between the lower surface 252 of the heater 220 and the print surface 108 of the build substrate 106. In embodiments, the vertical distance 268 ranges from about 0.5 millimeters to about 5 millimeters, including all values and ranges therein. The vertical distance 268 is determined based on several factors that include, but are not limited to, the temperature of the lower surface 252 of the heater 220, the heat absorption of the build material 258, a required temperature of the build material 258, print speed, and the geometry of the printed component 110.

In aspects, the adjustment assembly 270 includes a bolt 272 disposed in between two or more spring washer assemblies 274. The bolt 272 secures the mounting fixture 218 to the tool head 216. The spring washer assemblies 274 each include a pin 276 and a plurality of spring washers 278 stacked on top of each other. As the bolt 272 is tightened, the pins 276 will slide upwardly, and the plurality of spring washers 278 will compress against one another, which in turn increases the distance 268 between the lower surface 252 of the heater 220 and the print surface 108 of the build substrate 106. Other adjustment assemblies 270 may include mechanical or electro-mechanical assemblies including one or more linear actuators including ball screws, lead screws, rack and pinion, belt drives, and cam actuators, hydraulic actuators, pneumatic actuators, piezoelectric actuators, coiled actuators, telescoping actuators, etc.

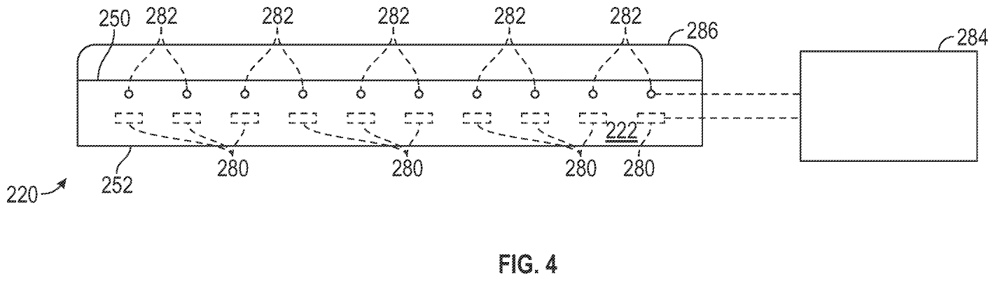

FIG. 4 is a schematic diagram of the heater 220 including one or more heating elements 280 and one or more temperature sensors 282 that are embedded within the heat plate 222 of the heater 220. The one or more heating elements 280 and the one or more temperature sensors 282 are in electronic communication with a control module 152 that is part of the three-dimensional printer 10 (FIG. 1). The one or more heating elements 280 are configured to heat at least a portion of the heater 220 to a predefined temperature. As explained below, the volume of hot air 236 (seen in FIG. 2) is created between the heater 220 and the printed component 110 when at least a portion of the heater 220 is heated to the predefined temperature. It is to be appreciated that print speed and geometry of the printed component 110 may change during the print cycle. Accordingly, the predetermined temperature may be modulated during a particular print cycle as well to accommodate the changes in print speed and part geometry. As also explained below, the one or more heating elements 280 may heat the entire heater 220 to the predetermined temperature or, in the alternative, may only heat a portion of the heater 220 to the predefined temperature.

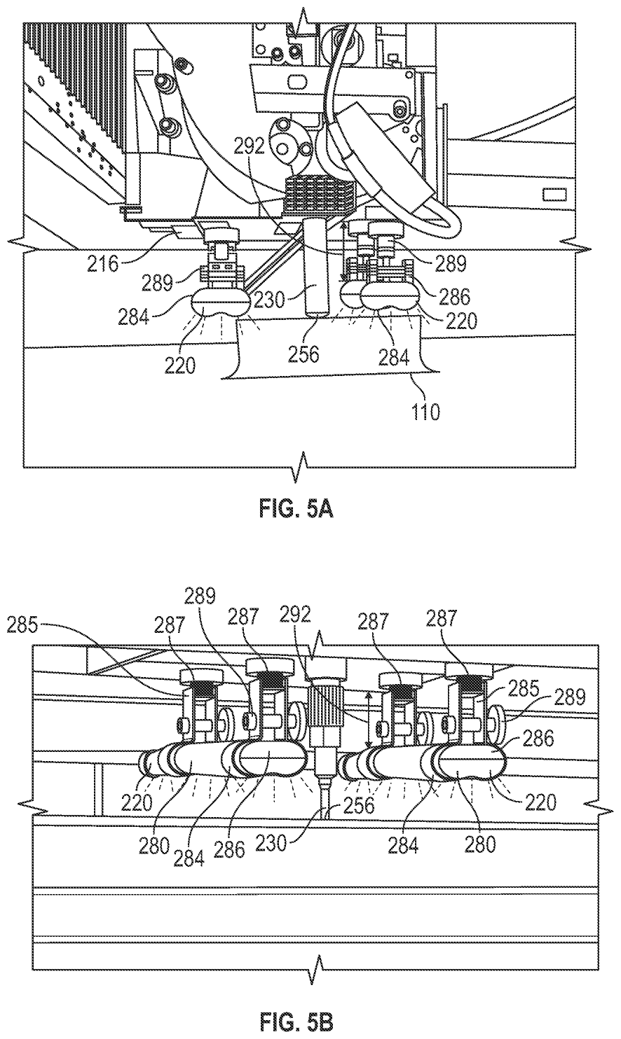

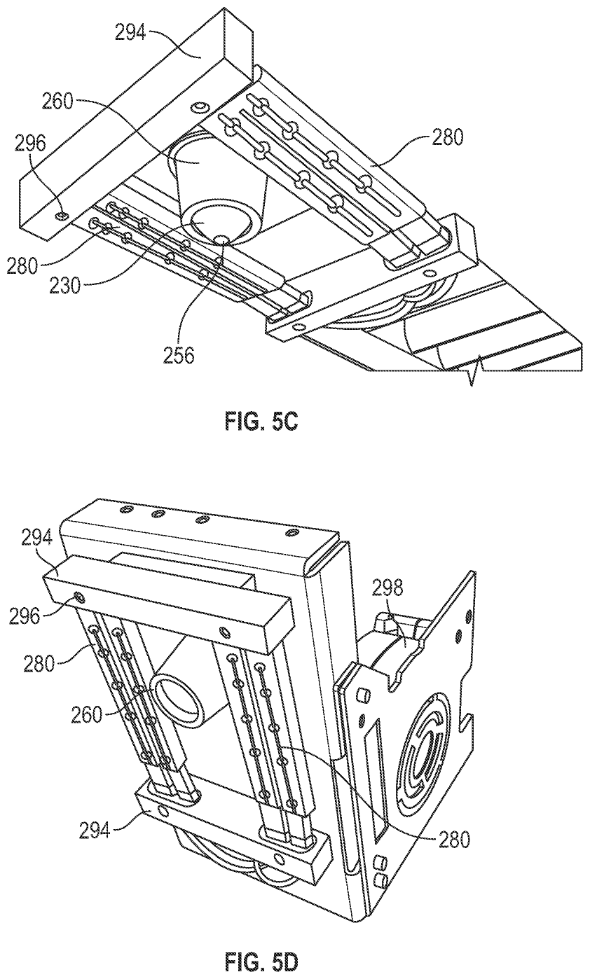

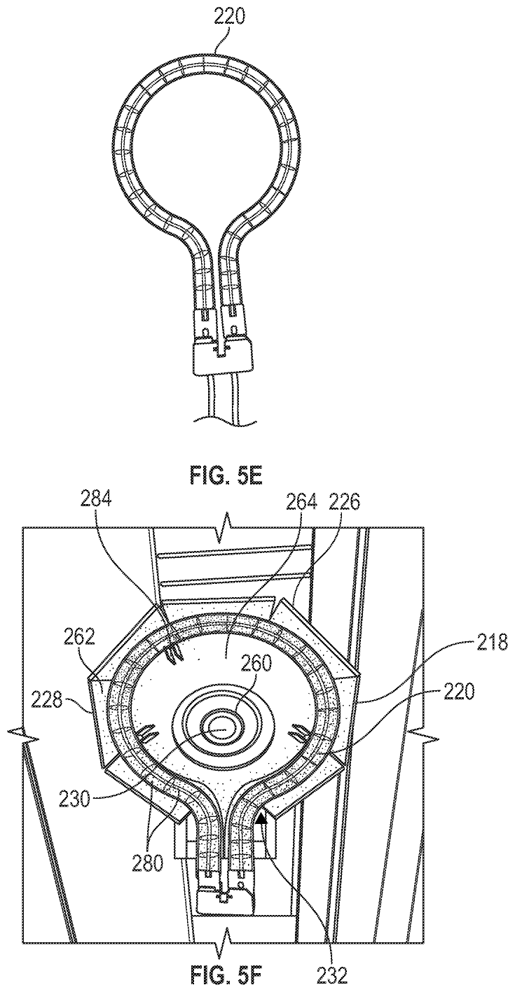

Although FIG. 4 illustrates the one or more heating elements 280 are embedded within the heat plate 222 of the heater 220, it is to be appreciated that the one or more heating elements 280 may also be disposed along the upper surface 250 of the heater 220 or along one or more side surfaces 288 (FIG. 2) of the heat plate 222 as well. In another embodiment, the one or more heating elements 280 are not embedded within the heat plate 222 of the heater 220 or disposed along the upper or side surfaces 250, 288, and instead is positioned in a location adjacent to the heat plate 222. For example, the heating element 280 may be an infrared lamp positioned adjacent to the heat plate 222, where the infrared lamp emits infrared radiation. It should further be appreciated that the heat plate 222 may be omitted, such as illustrated in FIGS. 5A through 5F described below. The one or more heating elements 280 may be any type of element that generates heat such as, for example, a heater cartridge, resistive heaters, or nichrome wires.

FIGS. 5A and 5B illustrate aspects in which the single heater 220 of FIGS. 2 through 4 is replaced with two heaters 220 provided on either side of the nozzle 230. The heaters 220 each include heating elements 280 and are suspended from the tool head 216 with mounting fixtures. Again, the heating elements 280 include, for example, a heater cartridge, resistive heaters, nichrome wires, or infrared lamps as in the aspects illustrated. The heaters 220 are suspended using adjustable clamps 284, which are connected to the heated tool head 216 with bolts 287. The bolts 287 may be used to adjust the height 292 of the clamps 284 relative to the tool head 216 and nozzle tip 256. Other height adjustment assemblies may include those enumerated above, i.e., including one or more linear actuators including ball screws, lead screws, rack and pinion, belt drives, and cam actuators, hydraulic actuators, pneumatic actuators, piezoelectric actuators, coiled actuators, telescoping actuators, etc. As illustrated, the upper surface 250 of the heaters 220 include a reflective coating to reflect light emitted from the heating elements 280 onto the printed component 110. In the aspects illustrated in FIGS. 5A and 5B, the heaters 220 are shown as being oriented perpendicular with respect to axis 134 that is orthogonal to the print surface 108. In further aspects, the heaters 220 may be adjusted at an angle α from axis 134 extending orthogonally to the print surface 108, by adjusting the height of each bolt 287.

FIGS. 5C and 5D illustrate a further aspect in which the single heater 220 of FIGS. 2 through 4 is replaced with two heaters 220 provided on either side of the nozzle 230. The heaters 220 each include heating elements 280 that are suspended from the tool head 216 by mounting brackets 294. The height of the heating elements 280 may be adjusted within the mounting brackets 294 with set screws 296. In addition, a blower duct 260 is provided and surrounds the nozzle 230 to heat or cool the nozzle 230 as needed, depending on the feedstock 140. Air is provided to the blower duct 260 by a fan 298, which is fluidly connected to the blower duct 260.

FIGS. 5E and 5F illustrate yet a further aspect in which the heaters 220 of FIGS. 5A through 5D are replaced by a single, generally circular heater 220 that surrounds the perimeters of the nozzle 230 and, if present, the blower duct 260. In this example, the heater 220 includes one or more heating elements 280 and is suspended from the tool head 216 (illustrated in FIGS. 2 through 4) by a mounting fixture 218. The mounting fixture 218 includes one or more clamps 284, which are connected to the mounting fixture 218 by mechanical fasteners such as bolts or one or more welds, that mechanically retain the heater 220 in the mounting fixture 218 in a removable manner. In embodiments, the mounting fixture is a spring clip for holding the heater 220 to the mounting fixture. In addition, the mounting fixture 218 is in the form of a reflector 226, exhibiting a generally circular concave geometry to reflect radiant heat away from the tool head 216 and towards the component 110 and the last, or last couple, printed layers 242. As illustrated, the reflector 226 includes seven (7) walls 228 and an opening 232 for accommodating the connector of the heater 220, connecting the heater 220 to a power supply and the controller 152. The reflector 226 includes an exterior reflector wall 262 connected to an interior reflector wall 264, defining a volume in which the heater 220 is at least partially retained. In addition, the interior reflector wall 264 is spaced from the perimeters of the nozzle 230 and, if present, the blower duct 260. The spacing reduces thermal conductivity between interior reflector wall 264 and the perimeters of the nozzle 230 and, if present, the blower duct 260. The heater 220 may be an infrared lamp, where the infrared lamp emits infrared radiation. Alternatively, the heater 220 may include any type of element that generates heat such as, for example, a heater cartridge, resistive heaters, or nichrome wires.

In the case of infrared heaters 220, the heaters 220 may operate at a wattage in the range of 25 Watts to 1000 Watts, including all values and ranges therein. In addition, the infrared heaters 220 may emit electromagnetic radiation having one or more wavelengths of greater than 600 nm, such as in the range of 600 nm to 1,000 nm, including all values and ranges therein.

As illustrated in FIG. 4, the one or more temperature sensors 282 are also embedded within the heat plate 222. However, it is to be appreciated that FIG. 4 is merely exemplary in nature, and one or more temperature sensors 282 may also be placed along the upper surface 250 or along the side surfaces 288 of the heaters 220 instead. As illustrated in FIGS. 5A through 5D, temperature sensors may be positioned anywhere relative to the heating elements 280. The control module 152 monitors the one or more temperature sensors 282 for electronic signals indicating the temperature of the heater 220. More specifically, the electronic signals indicate the temperature of the lower surfaces 252 of the heaters 220. It is to be appreciated that the upper surface 250 of the heaters 220 may be kept cooler than the lower surface 252 of the heater 220, and the lower surface 252 of the heater 220 is used to heat the volume of hot air 236 (FIG. 3). In aspects, a layer of insulation 286 is disposed along the upper surface 250 of the heaters 220 illustrated in FIGS. 4, 5A, and 5B to minimize an amount of heat loss of the heater 220. In embodiments, the layer of insulation 286 is constructed of materials such as, but not limited to, ceramic coatings, mica sheets, or high-temperature foam.

The control module 152 determines a current temperature of the lower surface 252 of the heater 220 based on the electronic signals received from the one or more temperature sensors 282, and instructs the one or more heating elements 280 to increase, decrease, or maintain the temperature of the heater 220 based on the current temperature of the lower surface 252 the heater 220. Specifically, in an embodiment, the control module 152 instructs the one or more heating elements 280 to heat an entire portion of the lower surface 252 heater 220 to the predefined temperature. However, it is to be appreciated that the one or more heating elements 280 may heat only a portion of the lower surface 252 of the heater 220 to the predefined temperature based on the geometry of the printed component 110.

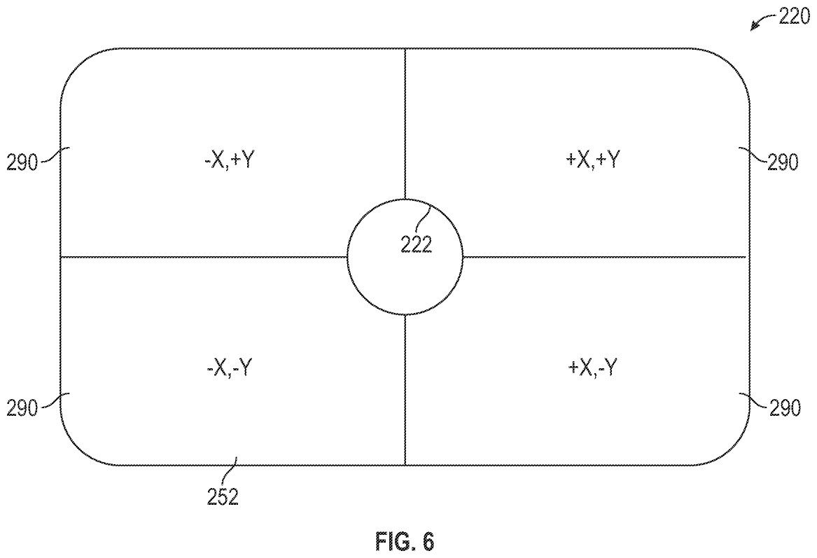

FIG. 6 is a bottom view of the heater 220 shown in FIGS. 2 and 3, illustrating the lower surface 252 of the heater 220. The lower surfaces 252 of the heater is divided into one or more sections 290. In the example as shown in FIG. 6, the lower surface 252 is divided into four sections 290, which are labeled as quadrants +x+y, −x+y, −x, −y, and +x−y. Referring to FIGS. 4 and 5, in an embodiment, the control module 152 instructs the one or more heating elements 280 to heat one or more sections 290 of the heater 220 to the predefined temperature. For example, only the +x+y section may be heated to the predefined temperature, while the remaining three sections 290 remain unheated.

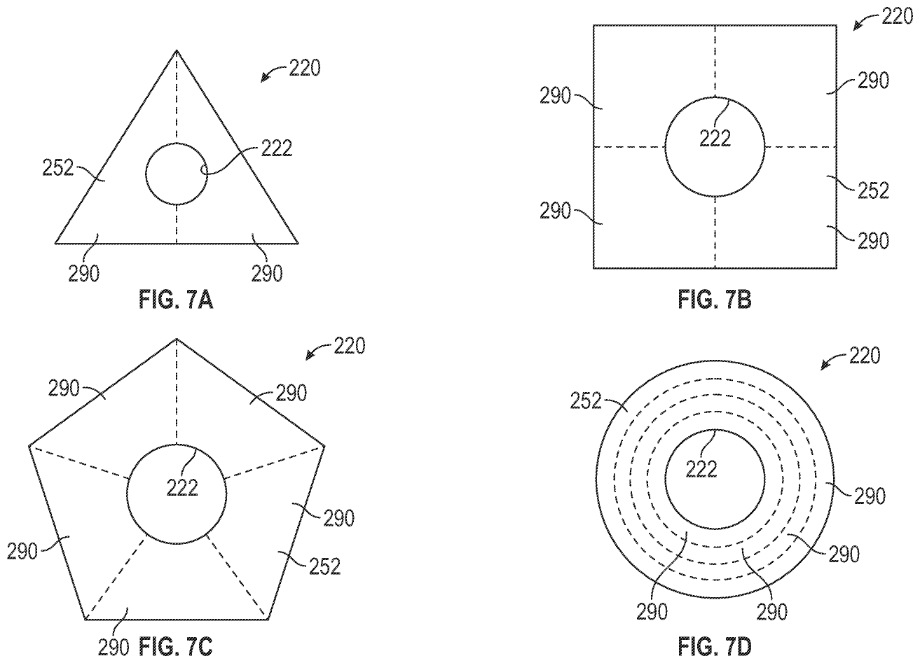

Although FIG. 6 illustrates the heater 220 including a rectangular profile, it is to be appreciated the heater 220 may include any number of different profiles. In the examples as shown in FIGS. 7A-7C, the heater 220 includes a variety of regularly shaped polygon profiles. For example, FIG. 7A illustrates the heater 220 including a triangular profile, FIG. 7B illustrates the heater 220 including a square profile and FIG. 7C illustrates the heater 220 including a pentagon profile. In the embodiment as shown in FIG. 7D, the heater 220 includes a circular profile. In the examples as shown in FIGS. 7A-7C, the lower surface 252 of the heater 220 is divided into equal sections 290 that include identical areas. However, in the embodiment as shown in FIG. 7D, the lower surface 252 of the heater 220 is divided into concentric sections 290. Further, as illustrated in FIGS. 5A and 5B, heaters 220 are provided on either side of the nozzle 230.

Turning back to FIG. 3, when the heater 220 is at the predetermined temperature for fusing or crosslinking, the volume of hot air 236 between the lower surface 252 of the heater 220 and the printed component 110 is at an air temperature that heats the portion 240 of the printed component 110 located on the build substrate 106 to a fusing or crosslinking temperature. Further, the printed component 110 may be heated to a desired depth D from the top of the printed component 110.

When using thermoplastic filament as a feedstock 140, the fusing temperature is a predefined margin below a heat deflection temperature of the feedstock 140. It is to be appreciated that the fusing temperature is close to but may not be equal to or exceed the heat deflection temperature of the feedstock 140. This is because heating the build material 258 to a temperature equal to or greater than the heat deflection temperature causes the printed component 110 to lose its respective shape or deform under its own weight. In an embodiment, the predefined margin ranges from about 10 to about 15 degrees Celsius, which prevents the printed component 110 from failing to retain its shape. As mentioned above, when the one or more successive layers 242 of the printed component 110 are heated to the fusing temperature, the one or more successive layers 242 of the printed component 110 bond to a current layer 244 presently being extruded by the nozzle 230. This improves the thermal history of the printed component 110. Improving the thermal history results in enhanced interlayer bonding between the successive layers 242 of the printed component 110, which in turn increases the tensile strength of the printed component 110 in the Z direction.

When using a thermoset resin as a feedstock 140, the crosslinking temperature is a temperature within a predefined margin sufficient to begin or expediate crosslinking of the feedstock 140 thermoset resin system components and at least partially solidify the feedstock 140 after a first pass of at least one of the heaters 220 over the printed component 110. In an embodiment, the predefined margin ranges from 175 to 300 degrees Celsius, including all values and ranges therein, which ensures that the printed component 110 retains its respective shape. The temperature range is decided based on the cure kinetics of the material with respect to temperature, often provided by the material supplier or experiments performed on a Differential Scanning Calorimeter (DSC). There are two principle equations associated with kinetics, referred to as the rate equation (Eq.1) and the Arrhenius equation (Eq. 2).

$$\begin{matrix}\frac{d α}{dt} = kf ( α ) & Eq . 1 ) \\ k = A exp ( \frac{- E}{RT} ) & Eq . 2 )\end{matrix}$$

The terms in these equations are as follows:

α=conversion or degree of cure (unitless),

$$\frac{d α}{dt} = rate of conversion ( {sec}^{- 1} ) ,$$

k=rate constant (sec⁻¹),

f(a)=kinetic model,

A=pre-exponential or frequency factor (sec⁻¹),

E=activation energy (kcal mol−1 or kJ mol), where J=joules,

R=gas constant (1.987 cal K−1 mol−1 or 8.314 J K−1 mol⁻¹), and

T=absolute temperature in Kelvin (K).

When the one or more successive layers 242 of the printed component 110 are deposited and heated to the crosslinking temperature, the one or more successive layers 242 of the printed component 110 bond to the current layer 244 being extruded by the nozzle 230. This improves the thermal history of the printed component 110. Improving the thermal history results in enhanced interlayer bonding between the successive layers 242 of the printed component 110, which in turn increases the tensile strength of the printed component 110 in the Z direction.

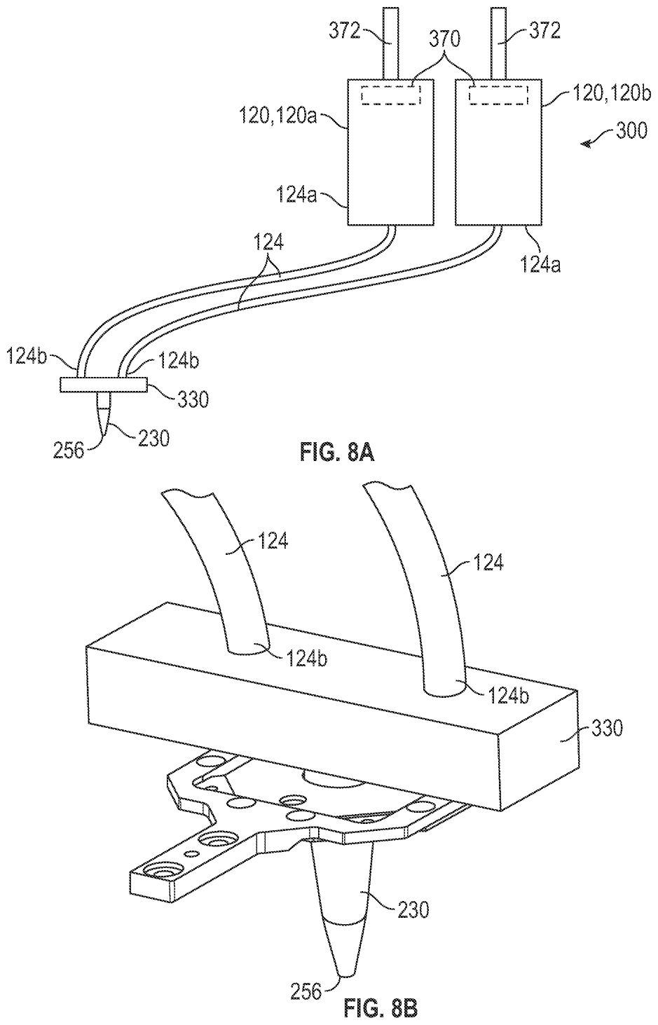

In the case of thermoset resin systems, the three-dimensional printer also includes a thermoset extrusion resin extrusion system 300. Reference is now made to FIGS. 8A and 8B, which illustrate an aspect of a thermoset extrusion system 300 integrated into the three-dimensional printer 100 for printing a thermoset resin. In aspects, the thermoset extrusion system 300 is sealed to prevent the leakage of thermoset resin from the system and to prevent air and moisture from entering the system except at the nozzle 230. The supply containers 120 store the thermoset resin system components. In the illustrated aspect, the thermoset resin is a two-part resin system including two reactive components; however additional components and additional supply containers 120 may be present, or only a single supply container 120 may be present for one-part thermoset resin systems. Each reactive component is stored in a supply container 120a, 120b. The supply containers 120 are coupled to a first and second flow path 124. A first end 124a of each flow path 124 is coupled to each supply container 120 and a second end 124b of each flow path 124 is connected to a nozzle 230.

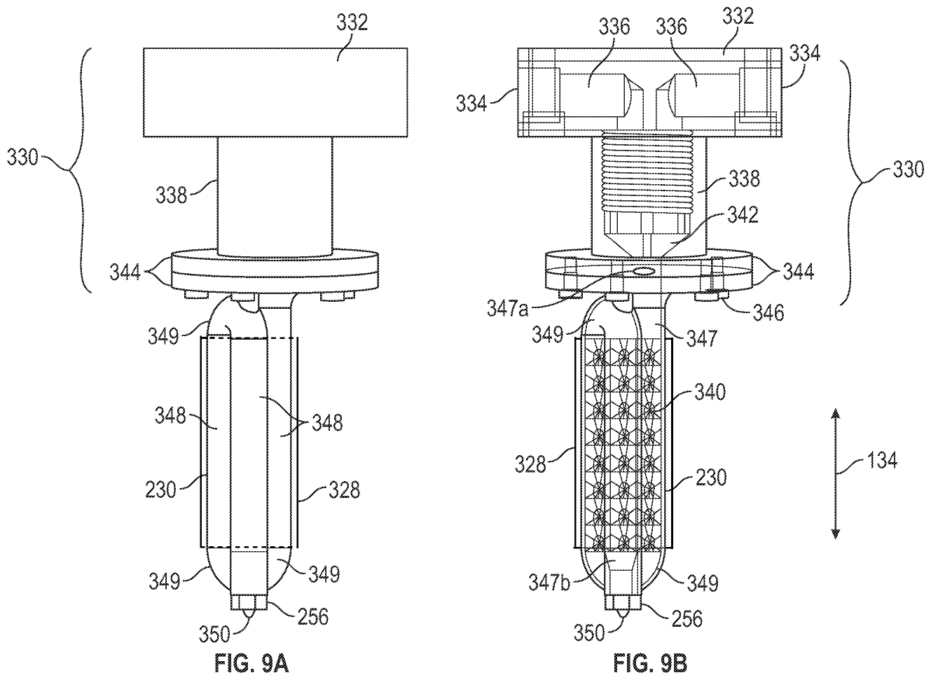

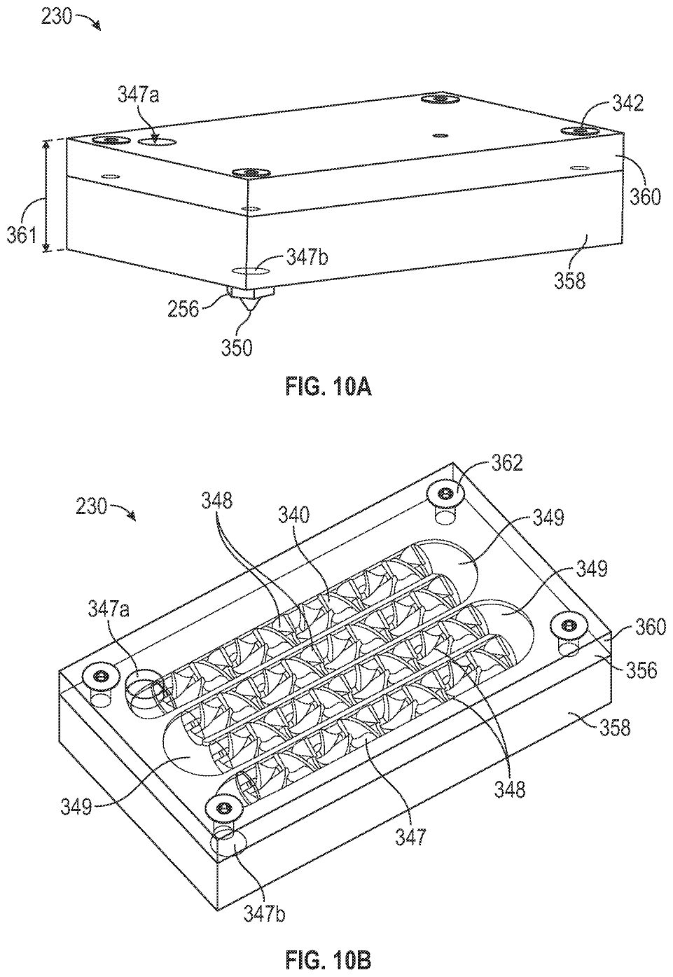

In aspects, the nozzle 230 is a mixing nozzle as described further with reference to FIGS. 9A, 9B, 10A, and 10B below. A buffer 330 is also connected to the nozzle 130. The thermoset resin supply flow paths 124 connect to the buffer 330 and the buffer 330 may include a one-way valve, preventing backflow of mixed thermoset resin into the flow paths 124. In such aspects, the buffer 330 provides one or more one-way valves to prevent backflow of mixed thermoset resin components into each of the flow paths 124.

FIGS. 9A and 9B illustrate a buffer 330 connected to an extrusion nozzle 230 and mixing elements 340 positioned within the nozzle 230. In the illustrated aspect, the buffer 330 includes a manifold 332 for receiving and combining the flow paths 124 for each thermoset resin component. The manifold 332 includes an opening 334 defined in each channel 336 for receiving the second end 324b of each resin component flow path 124. As illustrated the manifold 332 includes two channels; however, additional channels 336 may be present when more than two components are utilized in the thermoset resin system. The channels 336 extend through an adapter 338 connected to the manifold 332 and merge at the base 342 of the adapter 338. Both the nozzle 230 and the base 324 of the adapter 338 include a flange 344 for connecting the nozzle 230 to the base 324 of the adapter 338. The flange 344 of the adapter 338 is located adjacent the base 342 of the adapter and the flange 344 of the nozzle 230 is located adjacent to an entrance 347a to the nozzle 230. The flanges 344 are connected using mechanical fasteners 346, such as bolts, spaced around the flanges 344 to retain the adapter 338 against the nozzle 230. Further, a gasket (not illustrated) may be provided between the flanges 344 and a channel (not illustrated) may be formed within the flanges 344 for receiving and holding the gasket in place.

In the illustrated aspect, the nozzle 230 includes an elongate channel 347 that is looped and includes a plurality of legs 348, in the illustrated aspect three legs 348 are included, oriented generally parallel to each other and parallel to axis 134 illustrated in FIG. 3 and FIGS. 5A and 5B. The length of the channel 347 is in the range of 50 millimeters to 200 millimeters in length from entrance 347a to exit 347b, including all values and ranges therein such as 110 millimeters. The shortened length of the channel 347 is useful in reducing vibration and flexure of the nozzle 230 at the speeds that the three-dimensional printer operates at. A plurality of mixing elements 340 are included and retained in the legs 348 of the loop. As the thermoset resin passes through the mixing elements 340, the mixing elements 340 introduce turbulent flow and combine the thermoset resin components. The nozzle 230 further includes a nozzle tip 256, which provides an outlet 350. Each component of the system 300 is interchangeable and removable, which assists in removing the mixing elements 340 and cleaning out the nozzle 230 between prints or materials. For example, the legs 348 defining the elongate channel 347 may be disconnected from each other and the u-shaped passages 349 between the legs 348, the nozzle 230 may be removed from the manifold 332 and the nozzle tip 256 may be removed from the nozzle 230. In alternative aspects, the nozzle 230 includes a permanent tip (non-replaceable) 256. In circumstances where the nozzle 230 includes a permanent tip, a pressurized cleaning port, which prevents backflow, may be provided to clear the nozzle 230 with acetone or another solvent to “self-clean” the nozzle 230 into a waste container (not illustrated).

FIGS. 10A and 10B illustrate another arrangement for the mixing nozzle 230. In this arrangement, the nozzle 230 is cartridge shaped and channel 347 includes a series of legs 348 and u-shaped passages 349 that are arranged parallel to each other in a horizontal plane 356. In the illustrated aspect, the nozzle 230 is formed from two halves 358, 360, which define the channel 347. The mixing nozzle 230 is in the range of 10 millimeters to 25 millimeters in height 361, including all values and ranges therein, such as 18 millimeters in height 361, which increases the potential build height of the printed component 110. The mixing elements 340 are sandwiched between the two halves 358, 360 in the channel 347. The mixing elements 340 are removable to facilitate cleaning of the nozzle 230. The two halves 358, 360 are secured together with mechanical fasteners 362. A first end, the entrance 347a of the channel 347, is connected to a buffer 330, such as the buffer 330 illustrated in FIGS. 9A and 9B, and the second end, the exit 347b is connected to a nozzle tip 256 including an outlet 350. The legs 348 are oriented parallel to the axis 134 illustrated in FIG. 3 and FIGS. 5A and 5B; however, the legs 348 may be angled at an angle alpha from vertical V in alternative embodiments. The arrangement of this nozzle 230 allows for expanding of the mixing length by creating more legs 348 of the channel 347 and further allows for the mounting of cooling plates or heating plates on any of the exterior surfaces of the nozzle 230.

With reference, for example, to FIG. 9B, one or more layers of insulation 328 may be provided around the mixing nozzles 230 illustrated in FIGS. 8A, 8B, 9A, 9B, 10A, and 10B. The insulation may be formed from fiberglass sheet, fiberglass rope, cotton, graphite, ceramics such as calcium silicate, aluminum silicates, and non-woven fabrics of refractory ceramic fiber with or without foil. The insulation 230 may be secured in place with a potting compound, mechanical fasteners or a sheath, where the insulation is placed between the sheath and the nozzle. In addition to, or alternatively to the use of insulation 328, the nozzle 230 may be cooled using one or more cooling fans or by circulating a cooling medium around the surfaces of the mixing nozzle 230.

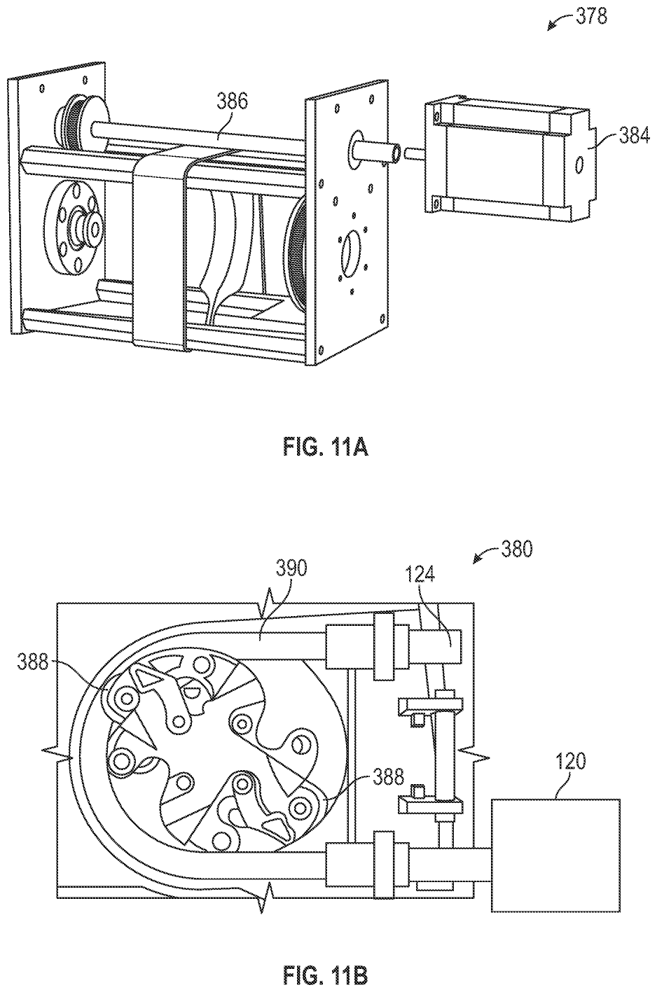

In aspects, the thermoset resin may be supplied in the supply containers 120 in cartridges or barrels. As illustrated in FIGS. 8A and 11A, pumps 166 are used for displacing the thermoset resin from the supply containers 120. In the aspect illustrated in FIG. 8A, pumps 370 are piston pumps and the pistons are ball screw pistons, driven by a motor. The pumps 370 apply pressure to the thermoset resin components in each pump 370, forcing the thermoset resin from the supply containers 120, through the flow paths 124, the buffer 330, and through the nozzle 230. In aspects including piston pumps 370, the pistons 372 are displaced using relatively high precision piston motion. The pistons 372 may be moved to reduce the volume within the supply containers 120, forcing the thermoset resin out, or the pistons 372 may be moved to increase the volume within the supply containers creating a negative pressure on the thermoset resin, retracting the thermoset resin through the thermoset extrusion system and back into the tip 256 of the nozzle 230. The pistons 372 may be moved at different rates or the same rate, depending on the thermoset resin components used and the desired properties of the thermoset resin. These pumps can also be peristaltic pumps with a specific gear ratio.

FIGS. 11A and 11B illustrate another aspect of a feed system 378 for dispensing thermoset resin components from a pump. The feed system 378 includes peristaltic pump 380. Each peristaltic pump 380 is driven by a motor 384 and each pump 380 may be driven at a different rate. Alternatively, the pumps 380 may be driven by a single motor. Each motor 384 drives a shaft 386, which drives spring loaded rollers 388. The spring-loaded rollers 388 compress tubing 390 that is connected to the supply container 120 and the flow path 124 to which the feed system 378 is coupled. As the spring rollers 388 are rotated and compress the tubing 390, pressure is applied within the 120 containers to force the thermoset resin components contained therein into the tubing 390. In aspects, the spring rollers 388 may be replaced by a rotor, which similarly applies pressure and compresses the tubing 390. FIG. 11C illustrates the supply containers 120.

As noted above, the three-dimensional printer 100 including the heaters 220 may be used with either thermoplastic filament or thermoset resins. Thermoplastic materials include one or more of the following materials: polyamide, polylactic acid, polyester, polyetherimide, acrylonitrile-butadiene-styrene, polycyclohexylenedimethylene terephthalate, polyetheretherketone, polyetherketoneketone, polypropylene, polyphenylene sulfide, and thermoplastic polyurethane. In aspects, the thermoplastic filament includes more than one material, for example a coating layer of a first material may be provided over a core of a second material. Further, various additives may be present in the thermoplastic materials including electrically active particles, which are described further herein.

Alternatively, thermoset resin systems may be used with the heaters 220 described herein. Thermoset resin for use herein include, in aspects, one or two component resins systems. The one component or two component resin systems for use herein include epoxy, liquid silicone systems, polyurethane, polyester, phenolic, and polyurethane systems. Liquid silicone systems include, for example, two-part liquid silicon systems, such as SYLGARD 184 available from DOW, Midland, MI. The thermoset resins, exposed to heat upon extrusion from the nozzle 230 cure, at least partially, at print speeds, up to 50 millimeters per second, including all values and ranges from 0.1 millimeters per second to 50 millimeters per second. Curing is understood as polymer reactions that occur between the components, such as polymer chains, oligomers, etc., in the thermoset resin system. When the extruded resin partially cures, sufficient polymer reactions occur between the components of the resin system to provide dimensional stability of the printed component 110. However, some potential reactions may remain. A portion of these remaining reactions may occur between the successive layers 242 and the current layer 244 being deposited. In aspects, at least one of the thermoset resin system components includes an additive including electrically active particles, which are described further herein.

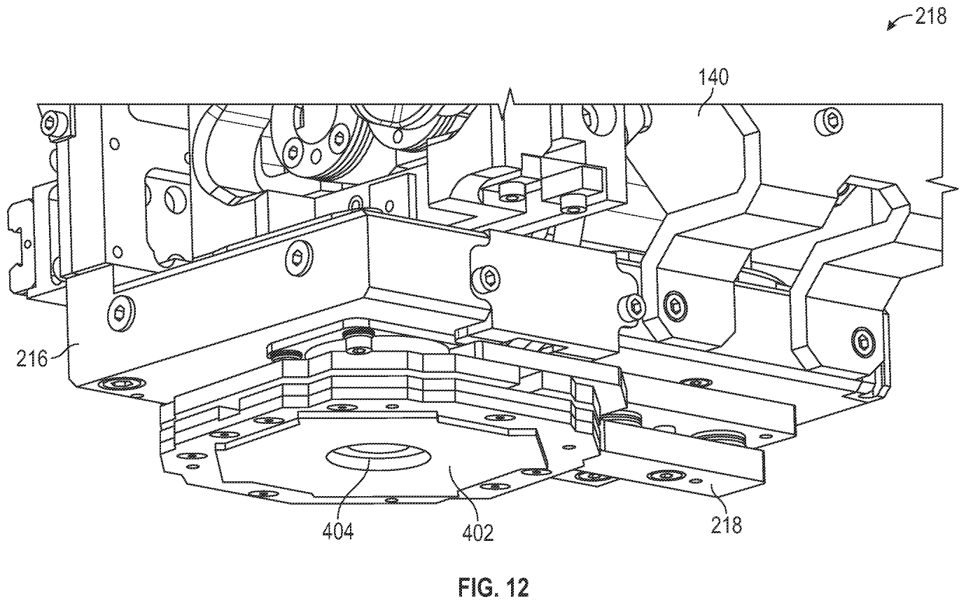

In aspects, the thermoplastic filament or thermoset resin system feedstocks 140 are mixed with particles that are susceptible to an electric field, conductive heat, or exposure to photons, such that upon exposure, the particles provide heat to the feedstock 140 in which they are incorporated. Particles susceptible to an electric field understood as being electrically active; particles susceptible to conductive heat are understood as being thermally active; and particles susceptible to photons are understood as being optically active. The particles heat upon exposure to the heaters 220 or an applied electric field (as described further herein with reference to FIG. 12) in an amount sufficient to heat the feedstock 140. In aspects, the particles are nanoparticles exhibiting a particles size of 1 micrometer or less, including all values and ranges from 10 nanometers to 1.0 micrometer, including all values and ranges therein. In aspects, the particles are nanoparticles exhibiting a particle size in the range of 100 nm to 300 nm, including all values and ranges therein. In alternative, or additional aspects, the particles are fibers exhibiting a length in the range of 2 micrometers to 60 micrometers including all values and ranges therein. Further, the particles are present in the thermoplastic or thermoset resin in a range of 0.005 percent by weight to 5 percent by weight of the feedstock 140, including all values and ranges therein, such as in the range of 0.01 percent by weight to 2.0 percent by weight of the thermoset resin. In the case of thermoset resins, the particles are included in at least one of the reactive components. If a two-part resin system is contemplated, the particles are included in one or both of the reactive components.

In aspects, the particles include silicon based particles, carbon based particles, or a combination of silicon and carbon based particles. In aspects, the particles include one or more of the following silicon carbide (SiC), silicon carbide nanowhiskers, silicon nanoparticles (Si NP or silicon NP), carbon fibers, carbon nanotubes, and multi-walled carbon nanotubes, graphene, graphite nanoparticles, etc. In additional or alternative aspects, the particles include semiconductor region particles which have a band gap in the range of 0.5 eV to 2.5 eV, including all values and ranges therein. Without being bound to any particular theory, such particles may interact with the electric fields and generate heat. Such materials include silicon, germanium, gray tin, alpha-tin, silicon carbide, gray selenium, red selenium, tellurium, boron phosphide, boron arsenide, aluminum phosphide, aluminum arsenide, aluminum antimonide, gallium phosphide, gallium arsenide, gallium antimonide, Indium nitride, indium phosphide, indium arsenide, indium antimonide, cadmium selenide, cadmium selenide, cadmium telluride, zinc telluride, sopper sulfide, lead selenide, lead sulfide, lead telluride, tin(II) sulfide, tin telluride, and copper indium selenide (CIS). The loading percentage depends on the base resin and nanoparticle selected. A specific conductivity range with a desired loading could be engineered for scale up purposes.

Accordingly, as alluded to above, in aspects the heaters 220 may be replaced with an electrical field applicator as illustrated in FIG. 12 in systems in which the feedstock 140 includes electrically active particles. The electrical field applicator 402 may replace the heater 220 and is be mounted to the underside of a print head 128 using a mounting fixture 218 as previously described with reference to the heater 220 illustrated in FIGS. 2 and 3. The electric field applicator 402 assumes the general shape of a plate. The electric field applicator 402 defines an opening 404 therein to allow a nozzle 230 to extend through the electric field applicator 402. Further, a power supply 410 is mounted to print head 128 and is electrically connected to the electric field applicator 402 to provide power to the electrical field applicator 402. The power provided to the electrical field applicator 402 is in the range of 1 Watt to 10 Watts, including all values and ranges therein, such as 5 Watts to 6 Watts. In aspects, the power supply delivers 15 kHz of AC power and 5 kV disc voltage. In such aspects, the print surface 108 is grounded.

In aspects using thermoset resin components, the particles are present at a level to interact with the electric field, conductive heat, or photons to create rapid internal joule heating that drives cure cycles to sub-minute scale without altering the chemistry of the resins and thus preserve the properties. Further, particles which do not change the material mechanical, thermal, magnetic, and chemical properties more than 10 percent of these properties could be dispersed within the thermoset resin that could induce heating effects throughout the thermoset resin system for relatively rapid cure to a partially solidified state of thermoset resin systems, such as a curing within sixty seconds of application of the electric field, including all values and ranges in the range of one second to 60 seconds such as 3 seconds to 20 seconds. That is the above referenced properties of the thermoset resins do not change more than 10 percent upon the addition of the particles. The particles absorb certain stimuli and respond by heating-up and increasing in temperature. It should further be appreciated that, in aspects, if the particles are present in amounts that are too high, it may cause the thermoset resin to pass too quickly through the partially cured state to complete cure and may even damage to the material upon exposure to an electric field or photons. If the particles are present in amounts that are too low, the cross-linking will not be initiated, and a partially cured state will not be achieved within the desired time period of less than 60 seconds, including all values and ranges between one seconds and 60 seconds, such as 3 seconds to 20 seconds.

Similarly, a resin with photo-active agents could be created/sourced by dispersing such nanoparticles/chemical initiators where auxiliary attachments to the gantry like photo stimulus devices like laser/infrared (IR)/near infrared (NIR) lamps or sonic generators respectively provide required stimulus. It is contemplated that the addition of the particles described herein could be extended to other thermoset systems such as vinyl esters, cyanate esters, polyesters, polyurethanes, phenolics, melamine, silicone, imide, acrylic, fluoropolymers, etc.

In another aspects, the thermoset resin system may be printed into a three-dimensional part, wherein a first layer is printed and then exposed to an electric field. The first layer then partially cures, preferably before the deposition of the next layer, to have sufficient mechanical strength to support the next layer. Then the next layer is deposited and exposed to the electric field to again achieve a partially cured state in the next layer. However, additional crosslinking reactions between the layers will occur forming interlayer bonds of the three-dimensionally printed component. It should therefore be appreciated that too much power applied during printing will cause curing past the partially crosslinked state preventing crosslinking between the layers and insufficient power applied will prevent the layer from reaching a partially cured state before the next layer is deposited and the printed part may fail. The power applied to the electric field applicator at a wattage in the range of 1 watt to 100 watts including all values and ranges therein, such as 5 watts to 6 watts. Further the discharge voltage is, in aspects, in the range of 5 kV to 10 kV, including all values and ranges therein. The applied AC current is, in aspects, 15 kHz, which may be derived from a 24 Volt DC power source. In addition, power may be applied in the range of a few seconds to a few minutes, depending on the loading amount and the wattage of the power.

In further aspects, a shell material may be molded, wherein the shell defines a cavity, and the thermoset resin system is disposed in the cavity, either through casting or printing. The thermoset resin system is then cured upon the application of a heat or an electric field. In further aspects, the shell material may be removed if desirable. For example, the shell may be dissolvable in a solvent, such as water, and dissolved away or the shell may be removed.

It is further envisioned that the thermoset resin systems may be deposited around a continuous fiber in the nozzle of a three-dimensional printer using continuous fiber extrusion through the three-dimensional printer. This allows printing of a thermoset/fiber composite lay-up.

It should be appreciated, however, that when forming parts using the thermoset resin systems described herein, it may be necessary to adjust and optimize the cure rate of the printed thermoset resin system. While it is important the layers to cure for 3D printing and to support the next layer in 3D printing, prior to deposition of next layers, it is also important the layers do not cure fully. If the layers cure fully, inter layer bonding will be an issue. Hence, by controlling the electric field intensity, we can control the cure rates and these electric field rates could be optimized based on the geometry to yield required inter layer bonding, cure times and thus final parts. It should therefore be appreciated that in regions of relatively higher print density, it may be necessary to reduce the voltage applied to the electric field applicator so as not to over cure the printed material. In this aspect, electric field is applied via a high voltage disk, maintained in the range of 5 kV to 8 kV with a frequency of 15 kHz, buried in a dielectric medium. Such disk can produce DBD (dielectric barrier discharge) plasma when the thermoset resin system, including the conductive particles, is brought into the electric field applicator vicinity range, between 0.01 mm to 2.0 mm from the disk surface, and thus drive current through the material where the DBD plasma acts as conductor. On this system, the duty cycle may be modulated to control the intensity of the applied electric field.

### EXAMPLES

The examples provided herein are illustrative and are not meant to limit the subject matter of the claims.

To test the effectiveness of the heater, in a first example, ZX plaques were printed in multiple materials and geometries both with and without the heaters illustrated in FIGS. 5A and 5B in accordance with ISO standards and specifically ISO 527. Tensile bars were then cut from the plaques using a router. Over 90 bars were tested. Forward looking infrared (FLIR) data was also captured with a thermal imaging device and the previous layer temperatures were recorded. When enabled, it was found that the heater increased the previous layer temperature of the plaques by 40 degrees Celsius while still maintaining dimensional accuracy as the heat was locally applied. The depth of heating until stabilization also increased by over 30 millimeters in using heaters 220 to approximately 60 millimeters. The increase in the depth of heating helps to promote interlayer bonding.

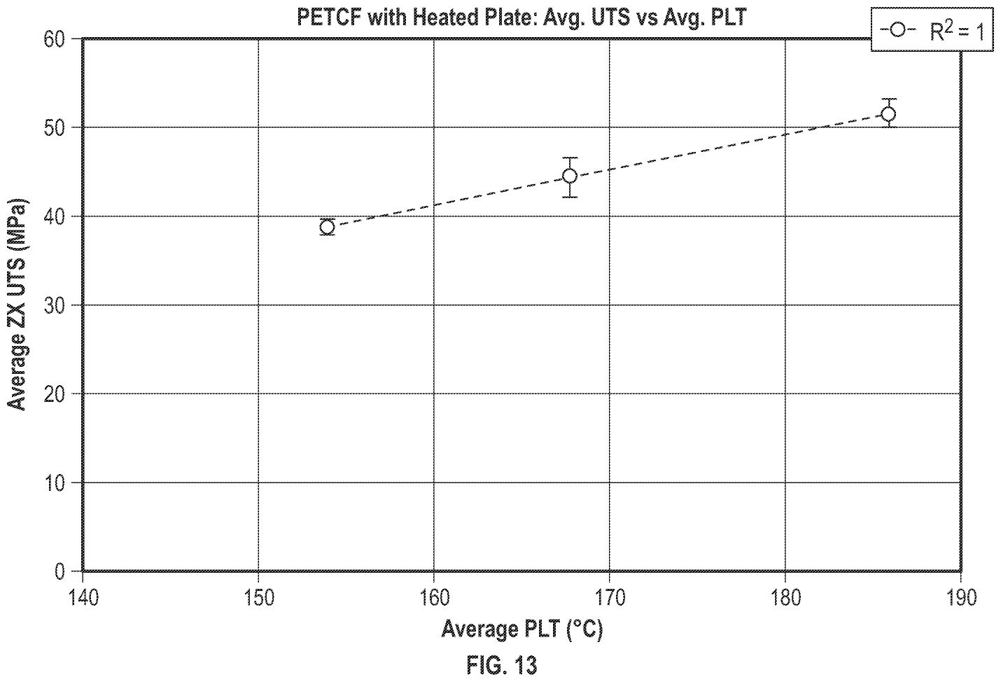

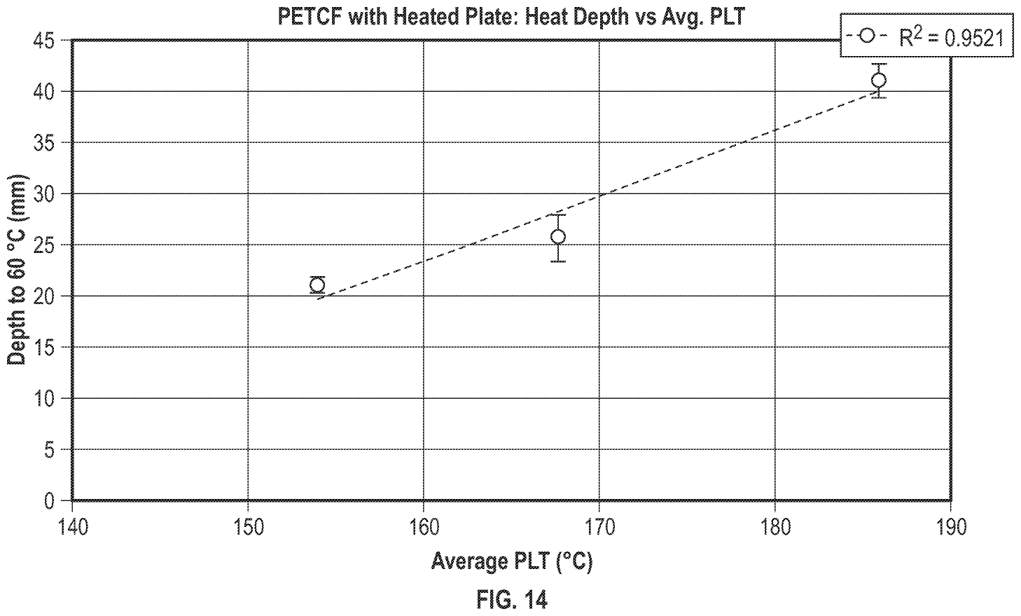

As illustrated in FIG. 13, the ultimate tensile strength of the samples linearly correlated to the previous layer temperature, and there was also a linear relationship between the depth and the previous layer temperature as illustrated in FIG. 14. In FIG. 13, tensile testing bars were made from carbon reinforced polyethylene terephthalate zx plaques. The average previous layer temperature was measured and adjusted by increasing heater 220 temperature. Further, the testing bars were testing according to ISO 527. As the average previous layer temperature increased, the average ZX ultimate tensile strength increased. In FIG. 14, tensile testing bars were made from the carbon reinforced polyethylene terephthalate zx plaques and testing in accordance with ISO 527. In making the plaques, the average previous layer temperature was determined at the depth at which the part measured at 60 degrees Celsius. It was determined that as the average previous layer temperature increased the depth to 60 degrees Celsius increased.

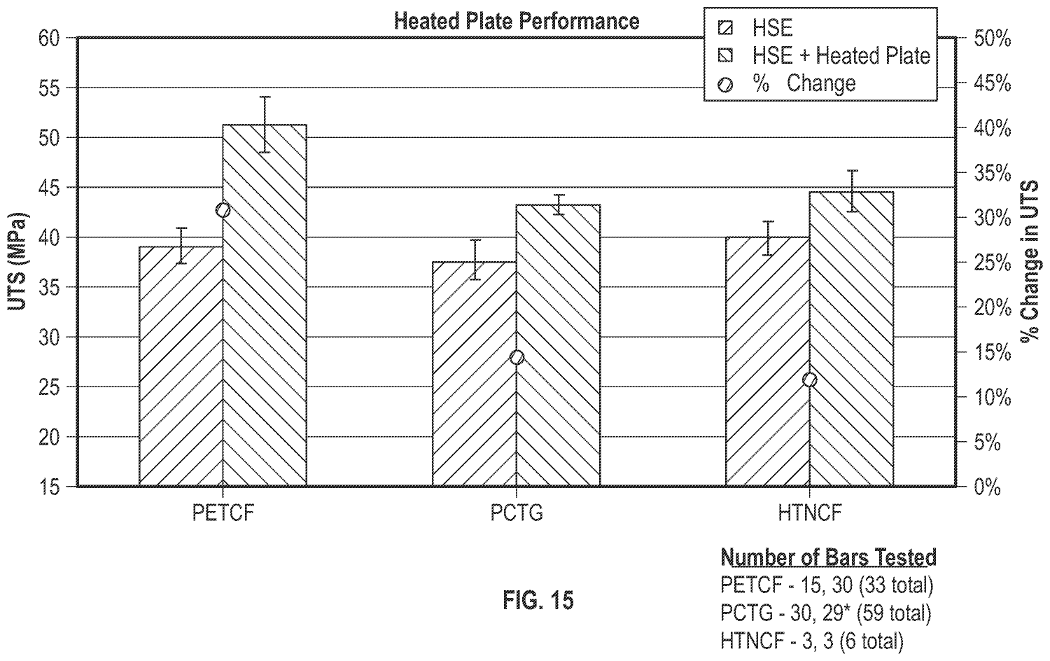

FIG. 15 illustrates the impact of using the heater across different materials. Specifically, tensile test bars were cut from plaques of carbon fiber reinforced polyethylene terephthalate (PETCF), polycyclohexylenedimethylene terephthalate glycol-modified (PCTG), and high temperature nylon with carbon fiber (HTNCF) formed both with and without the use of the heaters 220. The ultimate tensile strength was measured using ISO 527 and it was determined that for all three materials, an increase in ultimate tensile strength was measured. Overall, it was demonstrated that with the addition of the heater to the three-dimensional printer, the ZX tensile strength of PETCF consistently increased by over 30%, reaching an average ultimate tensile strength (UTS) of 51 megapascals (MPa), with the maximum value reaching 57 MPa. Filled materials will always have a significantly lower ZX tensile strength compared to the XY strength because the filling can never cross the layer boundaries, however, when using the heater, printed parts will be much stronger. The ZX tensile strength reached an average UTS of 43 MPa with the heater 220 enabled. Though there was only a 15% increase in tensile strength for PCTG when printing with the heater, the average ZX UTS with the heater reached 97% of the XY tensile strength for PCTG (44 MPa), making it near isotropic.

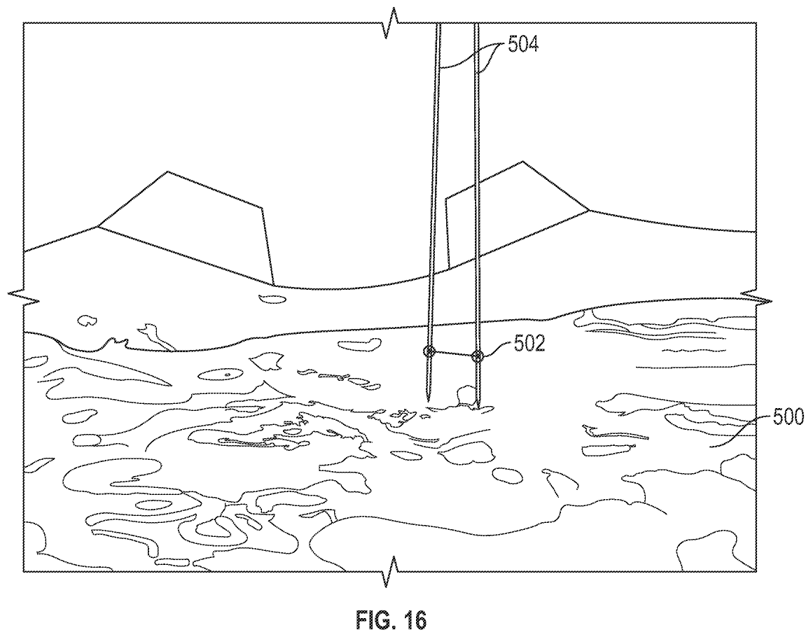

In a second example reference is made to FIG. 16, which illustrate a set of needles 502 and the thermoset resins system 500 described in the example above, wherein only a portion of the thermoset resin system was exposed to the electric field, specifically that portion under the left needle in the figure. Both needles 502 were marked with markings 504 at the same distance from the bottom of each needle 502. An attempt was then made to insert the needles 502 into the thermoset resin system 500. As illustrated in FIG. 16, the needle 502 on the right, positioned over the portion of the thermoset resin system 500 and not exposed to the electric field, sunk into the thermoset resin system. The needle 502 on the left, positioned over the portion of the thermoset resin system 500 that was exposed to the electric field, was not able to penetrate the thermoset resin system 500 exposed to the electric field.

In a third example, utilizing the electric field applicator illustrated in FIG. 12, several thermoset resin systems were tested, and the testing results are described herein. The thermoset resin systems used were 3M's SCOTCH-WELD adhesives, which are two-part epoxy systems, mixed with silicon carbide nano whiskers at a loading of 7.5 weight percent of the total weight of the thermoset resin system, 2.5 percent by weight of the total weight of the thermoset resin system and 5 percent by weight of the total weight of the resin system. An electric field was then applied to the thermoset resin systems including the particles using an electric field applicator 402 as illustrated in FIG. 12. The electric field was a non-contact high-voltage electric field applied using a dielectric barrier discharge plasma (DBD plasma) for a period of 10 second at 45 W of power applied to the electric field applicator. The application of the plasma reduced the time to a partially cured state from 60 minutes at room temperature to a sub-second times at room temperature. It was found that it was possible to control cure rate by changing particulate concentration and intensity of the electric field applied. It was also found that at loadings beyond 5 weight percent, such as at 7.5 weight percent, damaged the thermoset resin in some of the experiments.

In a further example, silicon carbide nano-whiskers were mixed into 3M SCOTCH-WELD COTS epoxy resin at a loading of 2.5 percent by weight of the total weight of the thermoset resin system. A non-contact, high voltage electric field was applied to the thermoset resins system using the electric field applicator 402 described with reference to FIG. 12 for five minutes at a power of 85 Watts applied to the electric field applicator 402. The cure time of the resin system was reduced from 60 minutes at room temperature to 5 minutes at room temperature. Again, the cure rate was found to be controllable changing particulate concentration and intensity of electric field applied.

In yet a further example, silicon carbide nano whiskers were mixed into 3M SCOTCH-WELD COTS epoxy resin at 5 percent by weight of the total weight of the thermoset resin system loading. A non-contact high-voltage electric field 402 described with reference to FIG. 12 was applied at various electric field intensities from 10 Watts to 85 Watts, to reduce cure time from 60 minutes at room temperature to 60 second to 1 second cure times at room temperature. Cure rate was also found to be affected by changing particulate concentration and intensity of the electric field applied.

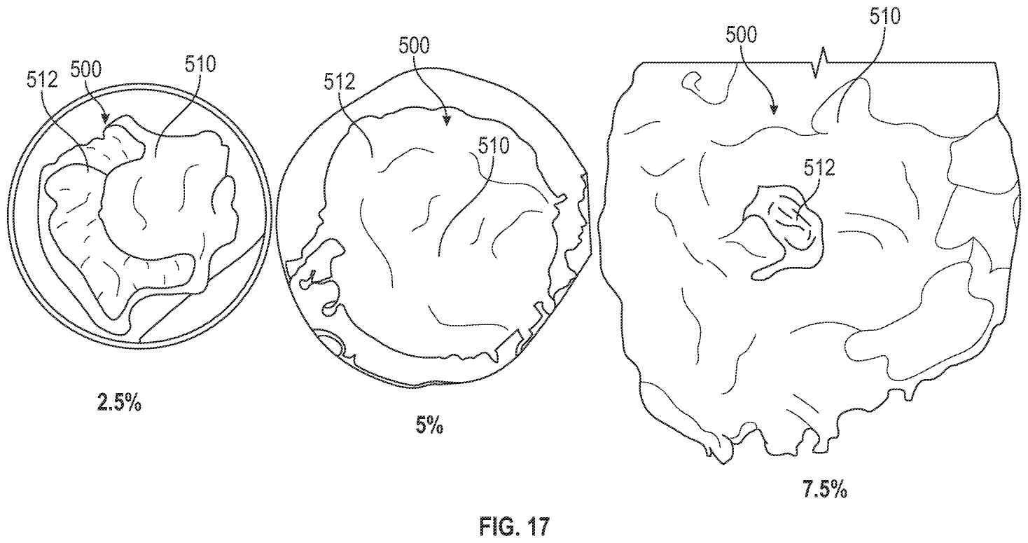

FIG. 17 is a representative illustration of the sample texture at the three particle loading conditions described above illustrating the texture and material damage caused by the process. In FIG. 17, the thermoset resin systems were at different weight loadings per total weight of the resin (2.5%, 5% and 7.5%), and exposed to 45 W of electric field until it was cured. During this experiment, the times were recorded and the type of connection and area of connection. As illustrated, a loading of 2.5% connected evenly, but on all the sections, hilly areas of the film connected more strongly than other areas. But the hilly area of the film has stronger effect at higher loadings. At 2.5% loading, the material was exposed for 360 seconds for the thermoset to cure and during this time, the hilly areas appeared to burn. At 5% loading, the thermoset resin system was exposed up to 60 seconds to cure and thus hilly areas see only slight burn, and at 7.5% loading, the center was hilly and it connected too strongly at the center and instantly burnt this area while curing only nearby areas.

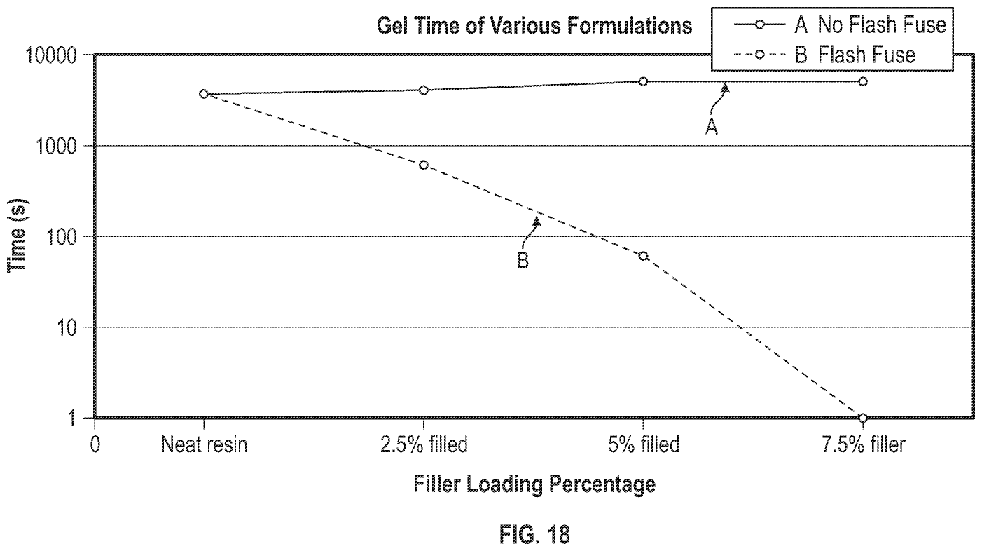

FIG. 18 is a graph of the cure time versus particle loading for the examples described above, without (line A) and with exposure to an electric field (B). As illustrated, exposure to the electric field at greater loadings decreased the cure time. In FIG. 18, the three loading percentages were exposed to electric field at 45 W and times were recorded until cured, curing as observed on the flat area, rather than the hilly areas. While 2.5% loading took 360 seconds to cure, 7.5% cured instantly on the connected area.

Referring generally to the figures, the heater provides various technical effects and benefits by providing a simple, cost-effective approach to improve the z-directional strength of the printed component. Preliminary results showed that the printed component maintained a 10° C. higher temperature during printing when using the heater versus a printed component that did not use the heater. Specifically, in aspects, the heater provides heat to the deposited thermoplastic or thermoset improving bonding between printed layers of the printed component. When used in combination with a thermoset resin, the heater provides sufficient thermal energy to at least partially cure the thermoset resin in place and to the preceding printed layer. In various aspects, the heater creates a volume of hot air located between the heater and the printed component. In the case of thermoplastic filament, the volume of hot air locally reheats the portion of the printed component to the fusing temperature. When reheated to the fusing temperature, the one or more successive layers of the printed component bond to a current layer presently being extruded by the nozzle, which improves the z-directional strength of the printed component.

The control module may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the control module may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications for executing the methods disclosed herein, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A three-dimensional printer for generating a printed component, the three-dimensional printer comprising:
a build substrate defining a surface that supports the printed component;
a print head moveable relative to the build substrate;
a nozzle mounted to the print head including a nozzle tip, and the nozzle additionally including a first channel defined therein, the first channel including a plurality of legs and a plurality of mixing elements retained within the legs; and
at least two heaters mounted to the print head by clamps or mounting brackets adjacent to the nozzle, each heater including one or more infrared lamps as heating elements.

2. The three-dimensional printer of claim 1, further comprising:
a buffer attached to the nozzle, wherein the buffer includes a manifold; and
at least two second channels defined in the manifold.

3. The three-dimensional printer of claim 2, wherein the manifold is connected to an adapter and the second channels extend through the adapter and merge at a base of the adapter.

4. The three-dimensional printer of claim 3, wherein the nozzle includes a first flange and the adapter includes a second flange and the first and second flanges are connected together to retain the adapter against the nozzle.

5. The three-dimensional printer of claim 3, further comprising at least two pumps, wherein each pump is connected to one of the at least two second channels defined in the manifold.

6. The three-dimensional printer of claim 5, wherein each pump includes a peristaltic pump.

7. The three-dimensional printer of claim 1, wherein the heaters include a main body that defines an opening for receiving the nozzle, and the one or more heating elements of each respective heater are configured to heat at least a portion of the respective heater to a predefined temperature.

8. The three-dimensional printer of claim 1, further comprising respective temperature sensors operatively coupled to a control module connected to each respective heating element of the heaters, wherein the control module is configured to execute instructions to:
monitor the respective temperature sensors for electronic signals indicating a temperature of a respective heater;
determine a current temperature of the respective heater based on the electronic signals from the respective temperature sensor; and
instruct the respective heating element to increase, decrease, or maintain the temperature of a respective heater based on the current temperature of the respective heater.
